(19) United States
(12) Patent Application Publication
(10) Pub. No.: US 2023/0252675 A1
(43) Pub. Date: Aug. 10, 2023

(54) MOBILE OBJECT CONTROL DEVICE, MOBILE OBJECT CONTROL METHOD, LEARNING DEVICE, LEARNING METHOD, AND STORAGE MEDIUM

(71) Applicant: HONDA MOTOR CO., LTD., Tokyo (JP)

(72) Inventors: Hideki Matsunaga, Wako-shi (JP); Yuji Yasui, Wako-shi (JP); Takashi Matsumoto, Wako-shi (JP); Gakuyo Fujimoto, Wako-shi (JP)

(21) Appl. No.: 18/106,589

(22) Filed: Feb. 7, 2023

(30) Foreign Application Priority Data
Feb. 10, 2022 (JP) 2022-019789

(51) Int. Cl. G06T 7/73; G06T 7/90; H04N 23/90; G06V 20/58; G06V 10/774; G06V 20/64; B60W 40/02; B60W 60/00

(52) U.S. Cl. CPC G06T 7/74; G06T 7/90; H04N 23/90; G06V 20/582; G06V 10/774; G06V 20/647; B60W 40/02; B60W 60/0016; G06T 2207/30261; G06T 2207/20081; G06T 2207/30256; G06T 2207/10024; B60W 2554/60; B60W 2420/42

(57) ABSTRACT

Provided is a mobile object control device comprising a storage medium storing computer-readable commands and a processor connected to the storage medium, the processor executing the computer-readable commands to: acquire a subject bird's eye view image obtained by converting an image, which is photographed by a camera mounted in a mobile object to capture a surrounding situation of the mobile object, into a bird's eye view coordinate system; input the subject bird's eye view image into a trained model, which is trained to receive input of a bird's eye view image to output at least a three-dimensional object in the bird's eye view image, to detect a three-dimensional object in the subject bird's eye view image; detect a travelable space of the mobile object based on the detected three-dimensional object; and cause the mobile object to travel so as to pass through the travelable space.

### CROSS-REFERENCE TO RELATED APPLICATION

The application is based on Japanese Patent Application No. 2022-019789 filed on Feb. 10, 2022, the content of which incorporated herein by reference.

### BACKGROUND

### Field of the Invention

The present invention relates to a mobile object control device, a mobile object control method, a learning device, a learning method, and a storage medium.

### Description of Related Art

Hitherto, the technology of using a sensor mounted in a mobile object to detect an obstacle existing near the mobile object. For example, Japanese Patent Application Laid-open 2021-162926 discloses the technology of using information acquired from a plurality of ranging sensors mounted in a mobile object to detect an obstacle existing near the mobile object.

The technology disclosed in Japanese Patent Application Laid-open 2021-162926 uses a plurality of ranging sensors such as an ultrasonic sensor or LIDAR to detect an obstacle existing near the mobile object. However, when adopting a configuration with a plurality of ranging sensors, the cost of the system tends to increase due to the complexity of the hardware configuration for sensing. On the other hand, a simple hardware configuration using only cameras may be adopted to reduce the system cost, but in this case, a large amount of training data for sensing is required to ensure robustness to cope with various scenes.

### SUMMARY

The present invention has been made in view of the above-mentioned circumstances, and has an object to provide a mobile object control device, a mobile object control method, a learning device, a learning method, and a storage medium that are capable of detecting the travelable space of a mobile object based on a smaller amount of training data without making the hardware configuration for sensing more complex.

A mobile object control device, a mobile object control method, a learning device, a learning method, and a storage medium according to the present invention adopt the following configuration.

(1) A mobile object control device according to one aspect of the present invention includes a storage medium storing computer-readable commands and a processor connected to the storage medium, the processor executing the computer-readable commands to: acquire a subject bird's eye view image obtained by converting an image, which is photographed by a camera mounted in a mobile object to capture a surrounding situation of the mobile object, into a bird's eye view coordinate system; input the subject bird's eye view image into a trained model, which is trained to receive input of a bird's eye view image to output at least a three-dimensional object in the bird's eye view image, to detect a three-dimensional object in the subject bird's eye view image; detect a travelable space of the mobile object based on the detected three-dimensional object; and cause the mobile object to travel so as to pass through the travelable space.

(2) In the aspect (1), the trained model is trained to receive input of a bird's eye view image to output information indicating whether or not the mobile object is capable of traveling so as to traverse a three-dimensional object in the bird's eye view image.

(3) In the aspect (1), the trained model is trained based on first training data associating an annotation indicating a three-dimensional object with a region having a radial pattern centered about a center of a lower end of the bird's eye view image.

(4) In the aspect (3), the trained model is trained based on the first training data and second training data associating an annotation indicating a three-dimensional object with a region having a single color pattern different from a color of a road surface in the bird's eye view image.

(5) In the aspect (3), the trained model is trained based on the first training data and third training data associating indicating a non-three-dimensional object with a road sign in the bird's eye view image.

(6) In the aspect (1), the processor uses an image obtained by capturing the surrounding situation of the mobile object by the camera to recognize an object included in the image, and generate a reference map in which a position of the recognized object is reflected, and the processor detects the travelable space by matching the detected three-dimensional object in the subject bird's eye view image with the generated reference map.

(7) In the aspect (1), the camera comprises a first camera installed at the lower part of the mobile object and a second camera installed at the upper part of the mobile object, the processor uses a first subject bird's eye view image, which is obtained by converting an image capturing the surrounding situation of the mobile object by the first camera into the bird's eye view coordinate system, to detect the three-dimensional object, the processor uses a second subject bird's eye view image, which is obtained by converting an image capturing the surrounding situation of the mobile object by the second camera into the bird's eye view coordinate system, to detect an object in the second subject bird's eye view image and position information thereof, and the processor detects a position of the three-dimensional object by matching the detected three-dimensional object with the detected object with the position information.

(8) In the aspect (1), the processor detects a hollow object shown in the image capturing the surrounding situation of the mobile object by the camera before converting the image into the bird's eye view coordinate system, and assigns identification information to the hollow object, and the processor detects the travelable space based further on the identification information.

(9) In the aspect (1), when a temporal variation amount of the same region in a plurality of subject bird's eye view images with respect to a road surface is equal to or larger than a threshold value, the processor detects the same region as a three-dimensional object.

(10) A mobile object control method according to one aspect of the present invention is to be executed by a computer, the mobile object control method comprising: acquiring a subject bird's eye view image obtained by converting an image, which is photographed by a camera mounted in a mobile object to capture a surrounding situation of the mobile object, into a bird's eye view coordinate system; inputting the subject bird's eye view image into a trained model, which is trained to receive input of a bird's eye view image to output at least a three-dimensional object in the bird's eye view image, to detect a three-dimensional object in the subject bird's eye view image; detecting a travelable space of the mobile object based on the detected three-dimensional object; and causing the mobile object to travel so as to pass through the travelable space.

(11) A non-transitory computer-readable storage medium according to one aspect of the present invention stores a program for causing a computer to: acquire a subject bird's eye view image obtained by converting an image, which is photographed by a camera mounted in a mobile object to capture a surrounding situation of the mobile object, into a bird's eye view coordinate system; input the subject bird's eye view image into a trained model, which is trained to receive input of a bird's eye view image to output at least a three-dimensional object in the bird's eye view image, to detect a three-dimensional object in the subject bird's eye view image; detect a travelable space of the mobile object based on the detected three-dimensional object; and cause the mobile object to travel so as to pass through the travelable space.

(12) A learning device according to one aspect of the present invention is configured to perform learning so as to use training data associating an annotation indicating a three-dimensional object with a region having a radial pattern centered about a center of a lower end of a bird's eye view image to receive input of a bird's eye view image to output at least a three-dimensional object in the bird's eye view image.

(13) A learning method according to one aspect of the present invention is to be executed by a computer, the learning method comprising performing learning so as to use training data associating an annotation indicating a three-dimensional object with a region having a radial pattern centered about a center of a lower end of a bird's eye view image to receive input of a bird's eye view image to output at least a three-dimensional object in the bird's eye view image.

A non-transitory computer-readable storage medium according to one aspect of the present invention stores a program for causing a computer to perform learning so as to use training data associating an annotation indicating a three-dimensional object with a region having a radial pattern centered about a center of a lower end of a bird's eye view image to receive input of a bird's eye view image to output at least a three-dimensional object in the bird's eye view image.

According to the aspects (1) to (14), it is possible to detect the travelable space of a mobile object based on a smaller amount of training data without making the hardware configuration for sensing more complex.

According to the aspects (2) to (5) or (12) to (14), it is possible to detect the travelable space of a mobile object based on a further smaller amount of training data.

According to the aspect (6), it is possible to detect the travelable space of a mobile object more reliably.

According to the aspect (7), it is possible to detect existence of a three-dimensional object and the position thereof more reliably.

According to the aspect (8) or (9), it is possible to detect a three-dimensional object that hinders traveling of a vehicle more reliably.

### BRIEF DESCRIPTION OF THE DRAWINGS

FIG. 1 is a diagram illustrating an exemplary configuration of a subject vehicle M including a mobile object control device according to an embodiment of the present invention.

FIG. 2 is a diagram illustrating an example of a reference map generated by a reference map generation unit based on an image photographed by a camera.

FIG. 3 is a diagram illustrating an example of a bird's eye view image acquired by a bird's eye view image acquisition unit.

FIG. 4 is a diagram illustrating an exemplary travelable space on the reference map detected by a space detection unit.

FIG. 5 is a flow chart illustrating an example of a flow of processing to be executed by a mobile object control device.

FIG. 6 is a diagram illustrating an example of training data in the bird's eye view image to be used for generating a trained model.

FIG. 7 is a diagram for describing a difference between a near region and a far region of a subject vehicle in the bird's eye view image.

FIG. 8 is a diagram for describing a method of detecting a hollow object in the bird's eye view image.

FIG. 9 is a diagram for describing a method of detecting a three-dimensional object based on a temporal variation amount of the three-dimensional object in bird's eye view images.

FIG. 10 is a flow chart illustrating another example of a flow of processing to be executed by the mobile object control device.

FIG. 11 is a diagram illustrating an exemplary configuration of the subject vehicle including a mobile object control device according to a modification example of the present invention.

FIG. 12 is a diagram illustrating an example of a bird's eye view image acquired by the bird's eye view image acquisition unit based on the image photographed by the cameras.

FIG. 13 is a flow chart illustrating another example of a flow of processing to be executed by the mobile object control device according to the modification example.

### DESCRIPTION OF EMBODIMENTS

Now, referring to the drawings, a mobile object control device, a mobile object control method, a learning device, a learning method, and a storage medium according to embodiments of the present invention are described below. The mobile object detection device is a device for controlling the movement action of a mobile object. The mobile object may include any mobile object that can move on a road surface, including vehicles such as three or four wheeled vehicles, motorbikes, micromobiles, and the like. In the following description, the mobile object is assumed to be a four-wheeled vehicle, and a vehicle equipped with a driving assistance device is referred to as “subject vehicle M”.

[Outline]

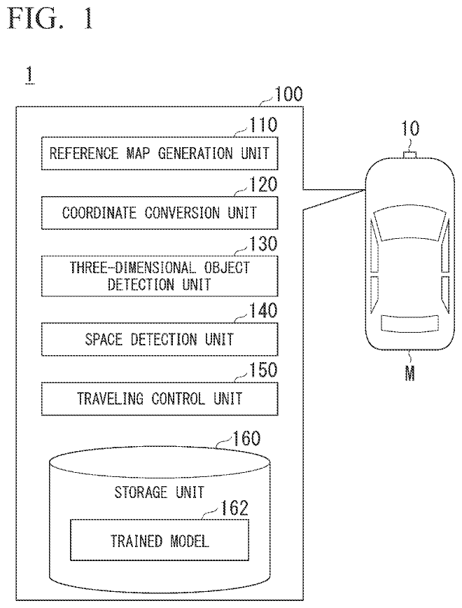

FIG. 1 is a diagram illustrating an exemplary configuration of the subject vehicle M including a mobile object control device 100 according to an embodiment of the present invention. As illustrated in FIG. 1, the subject vehicle M includes a camera 10 and a mobile object control device 100. The camera 10 and the mobile object control device 100 are connected to each other by multiple communication lines such as CAN (Controller Area Network) communication lines, serial communication lines, wireless communication networks, etc. The configuration shown in FIG. 1 is only an example, and other configurations may be added.

The camera 10 is a digital camera using a solid-state image sensor such as a CCD (Charge Coupled Device) or CMOS (Complementary Metal Oxide Semiconductor). In this embodiment, the camera 10 is installed on the front bumper of the subject vehicle M, for example, but the camera 10 may be installed at any point where the camera 10 can photograph the front field of view of the subject vehicle M. The camera 10 periodically and repeatedly photographs a region near the subject vehicle M, for example. The camera 10 may be a stereo camera.

The mobile object control device 100 includes, for example, a reference map generation unit 110, a bird's eye view image acquisition unit 120, a three-dimensional object detection unit 130, a space detection unit 140, a traveling control unit 150, and a storage unit 160. The storage unit 160 stores a trained model 162, for example. These components are implemented by a hardware processor such as a CPU (Central Processing Unit) executing a program (software), for example. A part or all of these components may be implemented by hardware (circuit unit including circuitry) such as an LSI (Large Scale Integration), an ASIC (Application Specific Integrated Circuit), an FPGA (Field-Programmable Gate Array), or a GPU (Graphics Processing Unit), or may be implemented through cooperation between software and hardware. The program may be stored in a storage device (storage device including non-transitory storage medium) such as an HDD (Hard Disk Drive) or flash memory in advance, or may be stored in a removable storage medium (non-transitory storage medium) such as a DVD or CD-ROM and the storage medium may be attached to a drive device to install the program. The storage unit 160 is realized by, for example, a ROM (Read Only Memory), a flash memory, an SD card, a RAM (Random Access Memory), an HDD (Hard Disk Drive), a register, etc.

The reference map generation unit 110 applies image recognition processing using well-known methods (such as binarization processing, contour extraction processing, image enhancement processing, feature extraction processing, pattern matching processing, or processing using other trained models) to an image obtained by photographing the surrounding situation of the subject vehicle M by the camera 10, to thereby recognize an object in the image. The object is, for example, another vehicle (e.g., a nearby vehicle within a predetermined distance from the subject vehicle M). The object may also include traffic participants such as pedestrians, bicycles, road structures, etc. Road structures include, for example, road signs and traffic signals, curbs, median strips, guardrails, fences, walls, railroad crossings, etc. The object may also include obstacles that may interfere with traveling of the subject vehicle M. Furthermore, the reference map generation unit 110 may first recognize road demarcation lines in the image and then recognize only objects inside the recognized road demarcation lines, rather than recognizing all objects in the image.

Next, the reference map generation unit 110 converts the image based on a camera coordinate system into a bird's eye view coordinate system, and generates a reference map in which the position of the recognized object is reflected. The reference map is, for example, information representing a road structure by using a link representing a road and nodes connected by the link.

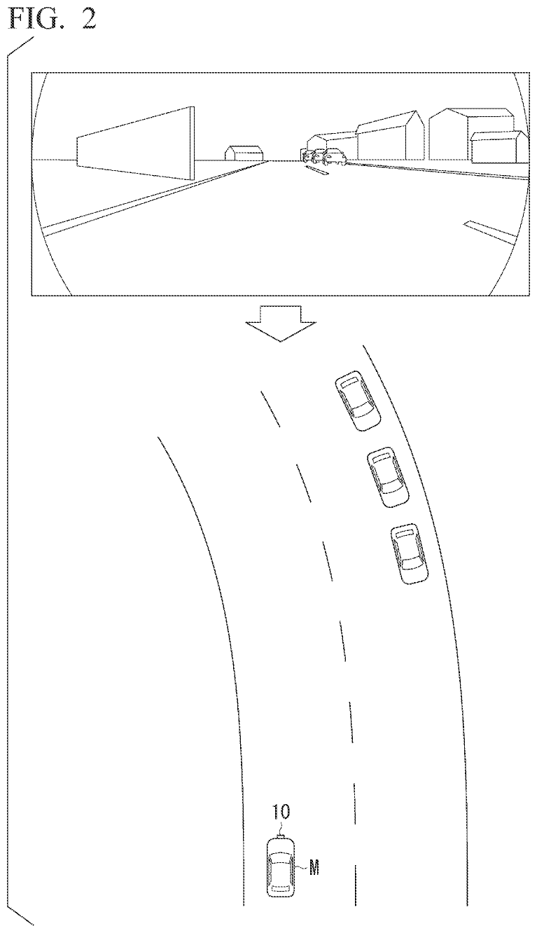

FIG. 2 is a diagram illustrating an example of the reference map generated by the reference map generation unit 110 based on an image photographed by the camera 10. The upper part of FIG. 2 represents an image photographed by the camera 10, and the lower part of FIG. 2 represents a reference map generated by the reference map generation unit 110 based on the image. As illustrated in the upper part of FIG. 2, the reference map generation unit 110 applies image recognition processing to the image photographed by the camera 10 to recognize an object included in the image, that is, a vehicle in front of the subject vehicle M. Next, as illustrated in the lower part of FIG. 2, the reference map generation unit 110 generates a reference map in which the position of the recognized vehicle in front of the subject vehicle M is reflected.

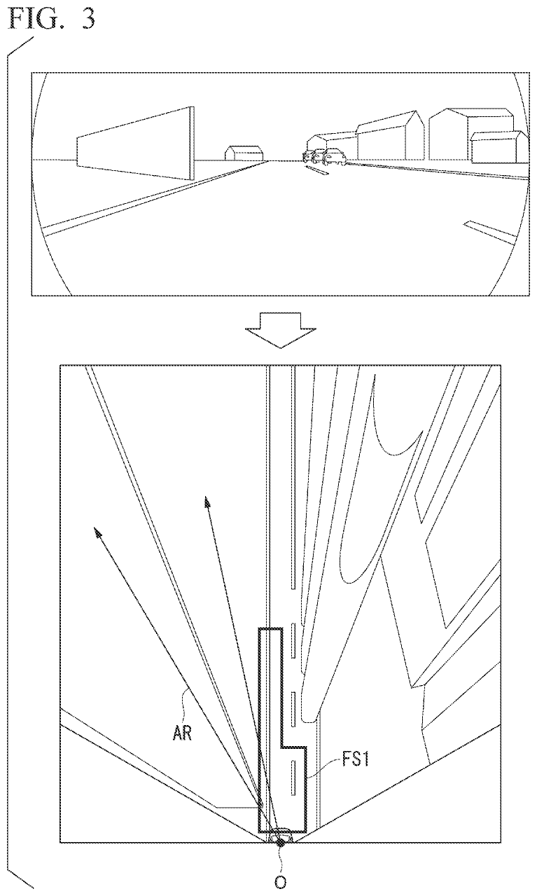

The bird's eye view image acquisition unit 120 acquires a bird's eye view image obtained by converting the image photographed by the camera 10 into the bird's eye view coordinate system. FIG. 3 is a diagram illustrating an example of the bird's eye view image acquired by the bird's eye view image acquisition unit 120. The upper part of FIG. 3 represents the image photographed by the camera 10, and the lower part of FIG. 3 represents the bird's eye view image acquired by the bird's eye view image acquisition unit 120 based on the photographed image. In the bird's eye view image of FIG. 3, the reference numeral O represents the installation position of the camera 10 in the subject vehicle M. As can be understood from comparison between the image illustrated in the upper part of FIG. 3 and the bird's eye view image illustrated in the lower part of FIG. 3, a three-dimensional object included in the image illustrated in the upper part of FIG. 3 is converted to have a radial pattern AR centered about a position O serving as a center in the bird's eye view image illustrated in the lower part of FIG. 3.

The three-dimensional object detection unit 130 inputs the bird's eye view image acquired by the bird's eye view image acquisition unit 120 into a trained model 162, which is trained to receive input of a bird's eye view image to output at least a three-dimensional object in the bird's eye view image, to detect a three-dimensional object in the bird's eye view image. A detailed generation method of the trained model 162 is described later.

The space detection unit 140 excludes the three-dimensional object detected by the three-dimensional object detection unit 130 from the bird's eye view image to detect a travelable space of the subject vehicle M in the bird's eye view image. In the bird's eye view image of FIG. 3, the reference numeral FS1 represents the travelable space of the subject vehicle M. The space detection unit 140 next converts coordinates of the travelable space FS1 of the subject vehicle M in the bird's eye view image into coordinates in the bird's eye view coordinate system, and matches the converted coordinates with the reference map to detect a travelable space FS2 on the reference map.

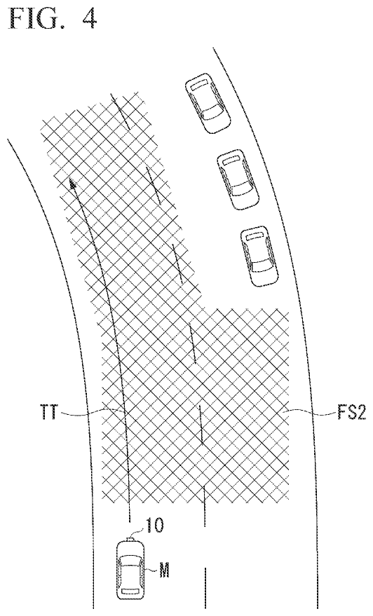

FIG. 4 is a diagram illustrating an exemplary travelable space FS 2 on the reference map detected by the space detection unit 140. In FIG. 4, the hatched region represents the travelable space FS2 on the reference map. The traveling control unit 150 generates a target trajectory TT such that the subject vehicle M passes through the travelable space FS2, and causes the subject vehicle M to travel along the target trajectory TT. The target trajectory TT includes, for example, a speed element. For example, the target trajectory is represented as an arrangement of points (trajectory points) to be reached by the subject vehicle M. The trajectory point is a point to be reached by the subject vehicle M every unit travel distance (for example, several meters [m]), and in addition, a target speed and target acceleration for every unit sampling time (for example, less than 0 second [sec]) are generated as a part of the target trajectory. Further, the trajectory point may be a position to be reached by the subject vehicle M at each sampling time for each sampling period. In this case, information on the target speed and target acceleration is represented at intervals of trajectory points. In the description of this embodiment, as an example, the present invention is applied to autonomous driving, but the present invention is not limited to such a configuration, and may be applied to driving assistance such as display of the travelable space FS2 not including a three-dimensional object on the navigation device of the subject vehicle M or assistance for operation of a steering wheel so as to pass through the travelable space FS2.

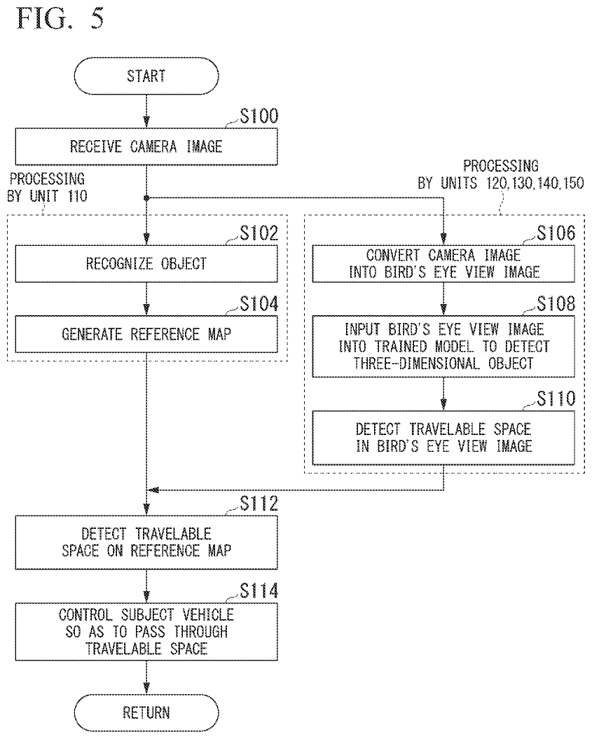

FIG. 5 is a flow chart illustrating an example of a flow of processing to be executed by the mobile object control device 100. First, the mobile object control device 100 acquires an image obtained by photographing the surrounding situation of the subject vehicle M by the camera 10 (Step S100). Next, the reference map generation unit 110 applies image recognition processing to the acquired image to recognize an object included in the image (Step S102). Next, the reference map generation unit 110 converts coordinates of the acquired image in the camera coordinate system into coordinates in the bird's eye view coordinate system, and generates a reference map in which the position of the recognized object is reflected (Step S104).

In parallel to the processing of Step S102 and Step S104, the bird's eye view image acquisition unit 120 acquires a bird's eye view image obtained by converting coordinates of the image photographed by the camera 10 into the bird's eye view coordinate system (Step S106). Next, the three-dimensional object detection unit 130 inputs the bird's eye view image acquired by the bird's eye view image acquisition unit 120 into the trained model 162 to detect a three-dimensional object in the bird's eye view image (Step S108). Next, the space detection unit 140 excludes the three-dimensional object detected by the three-dimensional object detection unit 130 from the bird's eye view image to detect the travelable space FS1 of the subject vehicle M in the bird's eye view image (Step S110).

Next, the space detection unit 140 converts coordinates of the travelable space FS1 into coordinates in the bird's eye view coordinate system, and matches the converted coordinates with the reference map to detect the travelable space FS2 on the reference map (Step S112). Next, the traveling control unit 150 generates a target trajectory TT such that the subject vehicle M passes through the travelable space FS2, and causes the subject vehicle M to travel along the target trajectory TT (Step S114). In this manner, the processing of this flow chart is finished.

[Generation of Trained Model 162]

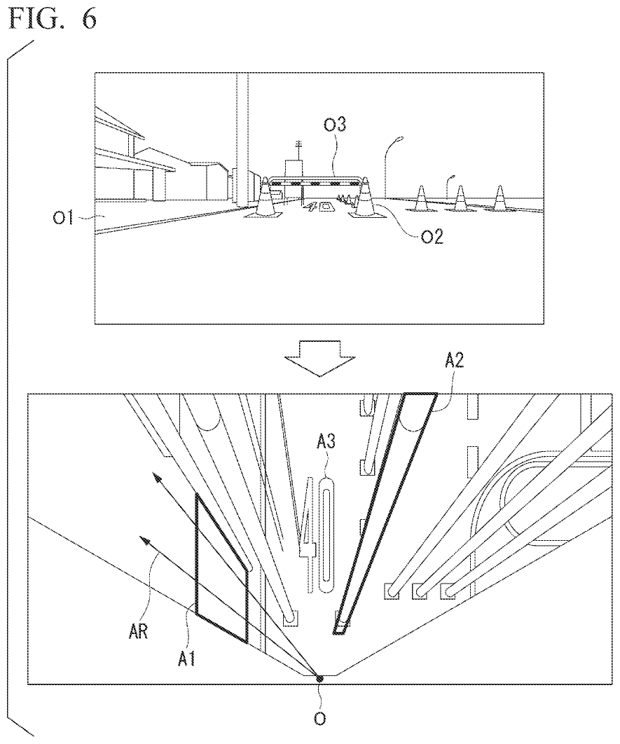

Next, referring to FIG. 6, description is given of a specific method of generating the trained model 162. FIG. 6 is a diagram illustrating an example of training data in the bird's eye view image to be used for generating the trained model 162. The upper part of FIG. 6 represents the image photographed by the camera 10, and the lower part of FIG. 6 represents the bird's eye view image acquired by the bird's eye view image acquisition unit 120 based on the photographed image.

In the bird's-eye view image in the lower part of FIG. 6, the reference numeral A1 represents a region corresponding to a curb O1 in the image in the upper part of FIG. 6. A region A1 is a region having a radial pattern centered about the center O of the lower end of the bird's-eye view image. In this manner, training data is generated by associating an annotation indicating a three-dimensional object with a region having a radial pattern centered about the center O of the lower end of the bird's-eye view image. This is because, in general, when a camera image is converted into a bird's-eye view image, a three-dimensional object in the camera image comes to have a radial pattern as a noise due to complementation of pixels caused by extension into the bird's-eye view image.

Further, in the bird's-eye view image in the lower part of FIG. 6, a reference numeral A2 represents a region corresponding to a pylon O2 in the image in the upper part of FIG. 6. The region A2 is a region having a single color pattern different from the color of a road surface in the bird's-eye view image. In this manner, training data is generated by associating an annotation indicating a three-dimensional object with a region having a single color pattern different from the color of a road surface in the bird's-eye view image. This is because, in general, when a camera image is converted into a bird's-eye view image, a clean three-dimensional object having a single color pattern in the camera image does not have a radial pattern in some cases even in a case where pixels are complemented due to extension into the bird's-eye view image.

Further, in the bird's-eye view image in the lower part of FIG. 6, a reference numeral A3 represents a region corresponding to a road surface sign O3 in the image in the upper part of FIG. 6. The region A3 is a region corresponding to a road surface sign in the bird's-eye view image. In this manner, training data is generated by associating an annotation indicating a non-three-dimensional object with a region corresponding to a road surface sign in the bird's-eye view image. This is because, in general, a region corresponding to a road surface sign has a single color in some cases, and thus the region may be determined as a three-dimensional object by conversion into a bird's-eye view image.

The mobile object control device 100 performs learning based on the training data configured as described above by using a technique such as a DNN (deep neural network), for example, to generate the trained model 162 trained so as to receive input of a bird's-eye view image to output at least a three-dimensional object in the bird's-eye view image. The mobile object control device 100 may generate the trained model 162 by performing learning based on training data further associating, with a region, an annotation indicating whether or not the subject vehicle M is capable of traveling so as to traverse a three-dimensional object. The traveling control unit 150 can generate the target trajectory TT more preferably by using the trained model 162 outputting information indicating whether or not the subject vehicle M is capable of traveling so as to traverse a three-dimensional object in addition to existence and position of the three-dimensional object.

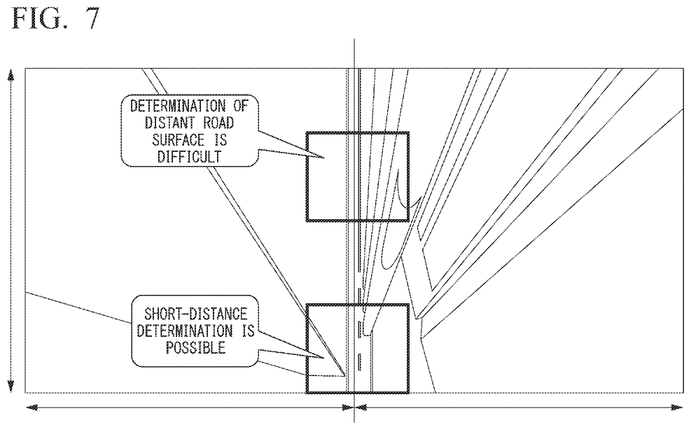

FIG. 7 is a diagram for describing a difference between a near region and a far region of the subject vehicle M in the bird's eye view image. In general, the number of pixels of the camera image per distance changes according to the distance from the camera 10, that is, the number of pixels of the camera image decreases as the distance from the camera 10 becomes further, whereas the number of pixels of a bird's eye view image per distance is fixed. As a result, as illustrated in FIG. 7, as the distance from the subject vehicle M including the camera 10 becomes larger, it becomes more difficult to detect a three-dimensional object in the bird's eye view image due to complementation of pixels.

The trained model 162 is generated by performing learning using a DNN method based on trained data associating an annotation with each of a near region and a far region of the subject vehicle M, and thus the trained model 162 already considers such influences. In addition, the mobile object control device 100 may further set a reliability that depends on the distance for each region of a bird's eye view image. In that case, the mobile object control device 100 may apply image recognition processing using well-known methods (such as binarization processing, contour extraction processing, image enhancement processing, feature extraction processing, pattern matching processing, or processing using other trained models) to the original image photographed by the camera 10 to determine existence of a three-dimensional object for a region for which the set reliability is smaller than a threshold value without using information on the three-dimensional object output by the trained model 162.

[Detection of Hollow Object]

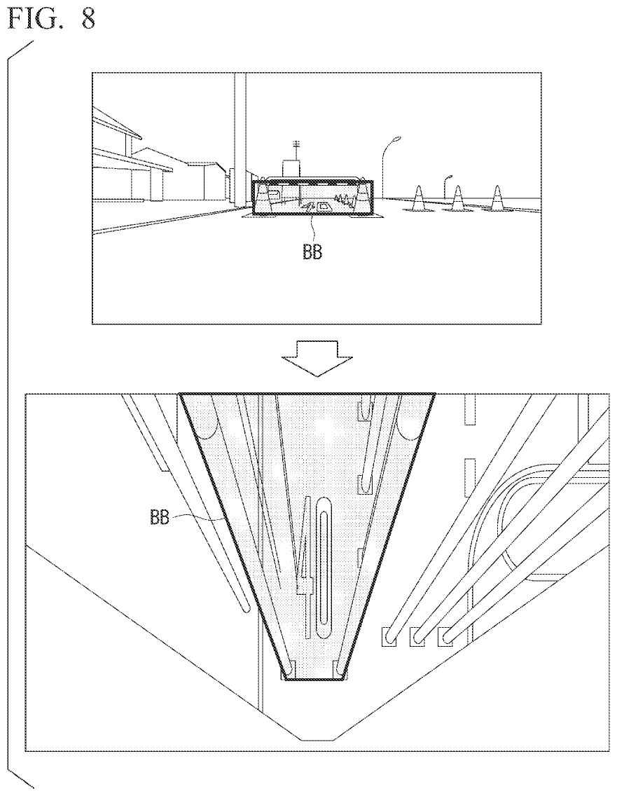

FIG. 8 is a diagram for describing a method of detecting a hollow object in the bird's eye view image. As illustrated in the bird's eye view image of FIG. 6, for example, a hollow object such as a bar connecting two pylons may not be detected by the trained model 162 because the area of the hollow object in the image is too small. As a result, the space detection unit 140 may detect a region between the two pylons as a travelable region and generate a target trajectory TT such that the subject vehicle M travels through the travelable region.

In order to solve the above-mentioned problem, before the image photographed by the camera 10 is converted into a bird's eye view image, the three-dimensional object detection unit 130 detects a hollow object shown in the image by using well-known methods (such as binarization processing, contour extraction processing, image enhancement processing, feature extraction processing, pattern matching processing, or processing using other trained models), and fits bounding box BB to the detected hollow object. The bird's eye view image acquisition unit 120 converts a camera image including the hollow object assigned with the bounding box BB into a bird's eye view image, and acquires a bird's eye view image shown in the lower part of FIG. 8. The space detection unit 140 excludes the three-dimensional object and bounding box BB detected by the three-dimensional object detection unit 130 to detect the travelable space FS1 of the subject vehicle M in the bird's eye view image. As a result, it is possible to detect a travelable space more accurately in combination with detection by the trained model 162. The bounding box BB is an example of “identification information”.

[Detection of Three-Dimensional Object Based on Temporal Variation Amount]

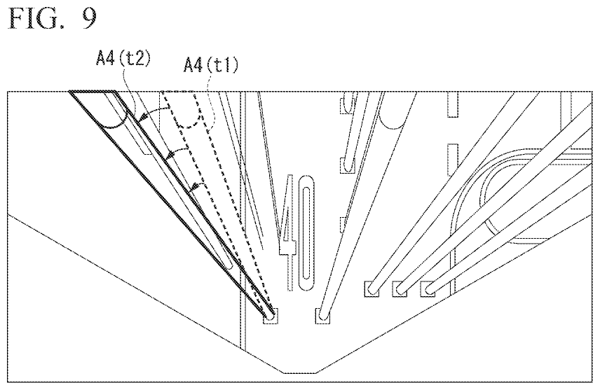

FIG. 9 is a diagram for describing a method of detecting a three-dimensional object based on a temporal variation amount of the three-dimensional object in bird's eye view images. In FIG. 9, the reference numeral A4(t1) indicates a pylon at a time point t1, and the reference numeral A4(t2) indicates a pylon at a time point t2. As illustrated in FIG. 9, for example, the region of a three-dimensional object in the bird's eye view image may be blurred with time due to the shape of the road surface on which the subject vehicle M travels. Meanwhile, such blur tends to become smaller as the camera becomes closer to the road surface. Thus, when a temporal variation amount of the same region in a plurality of time-series subject bird's eye view images with respect to a road surface is equal to or larger than a threshold value, the three-dimensional object detection unit 130 detects the same region as a three-dimensional object. As a result, it is possible to detect a travelable space more accurately in combination with detection by the trained model 162.

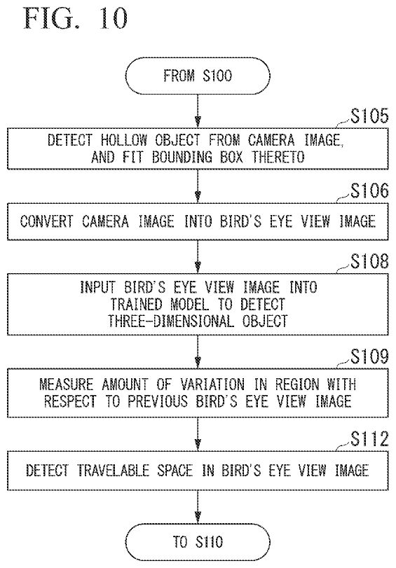

FIG. 10 is a flow chart illustrating another example of a flow of processing to be executed by the mobile object control device 100. The processing of Step S100, Step S102, Step S104, Step S112, and Step S114 in the flow chart of FIG. 5 is also executed in the flow chart of FIG. 10, and thus description thereof is omitted here.

After execution of the processing of Step S100, the three-dimensional object detection unit 130 detects a hollow object from a camera image, and fits a bounding box BB to the detected hollow object (Step S105). Next, the bird's eye view image acquisition unit 120 converts the camera image assigned with the bounding box BB into the bird's eye view coordinate system to acquire a bird's eye view image (Step S106). The hollow object of the bird's eye view image acquired in this manner is also assigned with the bounding box BB, and is already detected as a three-dimensional object.

Next, the three-dimensional object detection unit 130 inputs the bird's eye view image acquired by the bird's eye view image acquisition unit 120 into the trained model 162 to detect a three-dimensional object (Step S108). Next, the three-dimensional object detection unit 130 measures the amount of variation of each region with respect to the previous bird's eye view image, and detects a region for which the measured variation amount is equal to or larger than a threshold value as a three-dimensional object (Step S109). Next, the space detection unit 140 excludes the three-dimensional object detected by the three-dimensional object detection unit 130 from the bird's eye view image to detect the travelable space FS1 of the subject vehicle M in the bird's eye view image (Step S112). After that, the processing proceeds to Step S112. The processing of Step S108 and the processing of Step S109 may be executed in opposite order, may be executed in parallel, or either one thereof may be omitted.

According to the processing of the flow chart, the three-dimensional object detection unit 130 fits a bounding box BB to a hollow object to detect a three-dimensional object, inputs a bird's eye view image into the trained model 162 to detect a three-dimensional object included in the bird's eye view image, and detects a region for which the variation amount with respect to the previous bird's eye view image as a three-dimensional object. As a result, it is possible to detect a three-dimensional object more accurately compared to the processing of the flow chart of FIG. 5 in which only the trained model 162 is used to detect a three-dimensional object.

According to this embodiment described above, the mobile object control device 100 converts an image photographed by the camera 10 into a bird's eye view image, and inputs the converted bird's eye view image into the trained model 162, which is trained to recognize a region having a radial pattern as a three-dimensional object, to thereby recognize a three-dimensional object. As a result, it is possible to detect the travelable space of a mobile object based on a smaller amount of training data without complicating the hardware configuration for sensing.

### Modification Example

The subject vehicle M shown in FIG. 1 has a single camera 10 as its configuration. In particular, in the embodiment described above, the camera 10 is installed in the front bumper of the subject vehicle M, i.e., at a low position of the subject vehicle M. However, in general, a bird's eye view image converted from an image photographed by the camera 10 installed at a low position tends to be noisier than a bird's eye view image converted from an image photographed by the camera 10 installed at a high position. The intensity of this noise, which appears as a radial pattern, makes it suitable for the trained model 162 to detect a three-dimensional object, but on the other hand, it becomes more difficult to identify the position of a three-dimensional object. This modification example addresses such a problem.

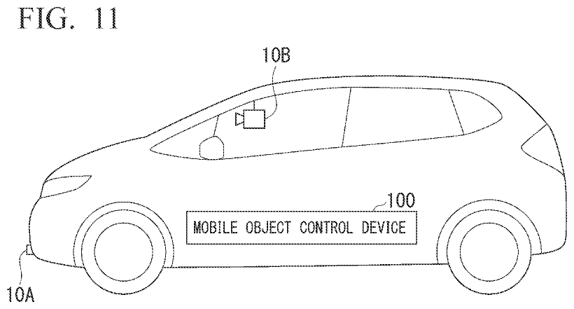

FIG. 11 is a diagram illustrating an exemplary configuration of the subject vehicle M including the mobile object control device 100 according to a modification example of the present invention. As illustrated in FIG. 11, the subject vehicle M includes a camera 10A, a camera 10B, and a mobile object control device 100. The hardware configurations of the camera 10A and the camera 10B are similar to those of the camera 10 according to the embodiment. The camera 10A is an example of “first camera”, and the camera 10B is an example of “second camera”.

Similarly to the camera 10 described above, the camera 10A is installed in the front bumper of the subject vehicle M. The camera 10B is installed at a position higher than that of the camera 10A, and is installed inside the subject vehicle M as an in-vehicle camera, for example.

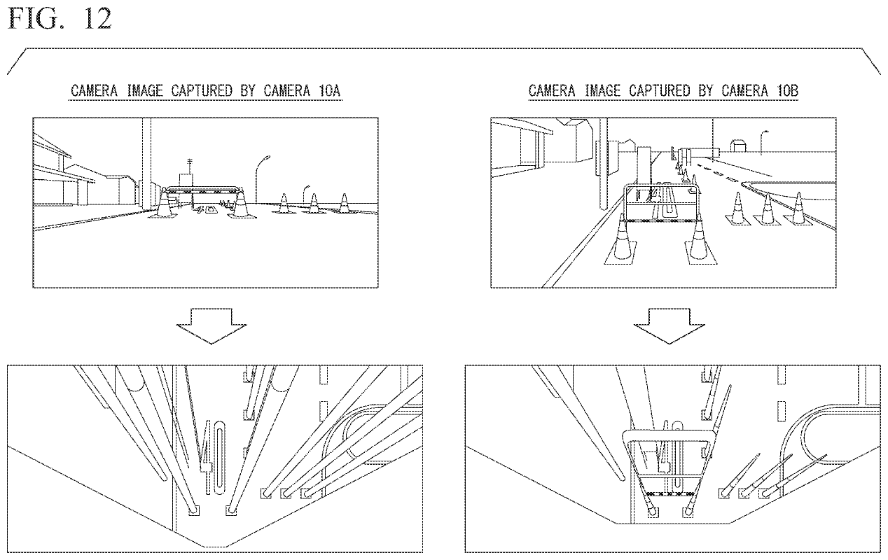

FIG. 12 is a diagram illustrating an example of a bird's eye view image acquired by the bird's eye view image acquisition unit 120 based on the images photographed by the camera 10A and the camera 10B. The left part of FIG. 12 represents an image photographed by the camera 10A and a bird's eye view image converted from the photographed image, and the right part of FIG. 12 represents an image photographed by the camera 10B and a bird's eye view image converted from the image. As can be understood from comparison between the bird's eye view image in the left part of FIG. 12 and the bird's eye view image in the right part of FIG. 12, a bird's eye view image corresponding to the camera 10A installed at a low position has a larger noise (stronger radial pattern) than a bird's eye view image corresponding to the camera 10B installed at a high position, which makes it more difficult to identify the position of a three-dimensional object.

In view of the above, the three-dimensional object detection unit 130 inputs a bird's eye view image corresponding to the camera 10A into the trained model 162 to detect a three-dimensional object, and detects an object (not necessarily three-dimensional object) with its position information identified in the bird's eye view image corresponding to the camera 10B by using well-known methods (such as binarization processing, contour extraction processing, image enhancement processing, feature extraction processing, pattern matching processing, or processing using other trained models). Next, the three-dimensional object detection unit 130 matches the detected three-dimensional object with the detected object to identify the position of the detected three-dimensional object. As a result, it is possible to detect a travelable space more accurately in combination with detection by the trained model 162.

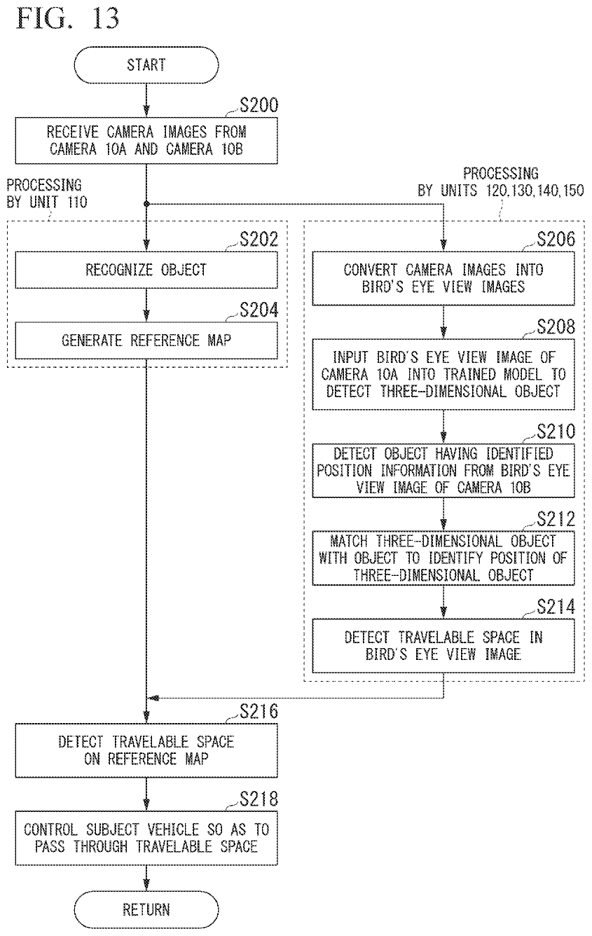

FIG. 13 is a flow chart illustrating another example of a flow of processing to be executed by the mobile object control device 100 according to the modification example. First, the mobile object control device 100 acquires an image obtained by photographing the surrounding situation of the subject vehicle M by the camera 10A and an image obtained by photographing the surrounding situation of the subject vehicle M by the camera 10B (Step S200). Next, the reference map generation unit 110 subjects the image photographed by the camera 10B to image recognition processing to recognize an object included in the image (Step S202). Next, the reference map generation unit 110 converts the acquired image based on the camera coordinate system into the bird's eye view coordinate system, and generates a reference map in which the position of the recognized object is reflected (Step S204). The camera 10B is installed at a higher position than that of the camera 10A, and can recognize an object in a wider range, and thus usage of the camera 10B is more preferable for generating a reference map.

In parallel to the processing of Step S202 and Step S204, the bird's eye view image acquisition unit 120 converts the image photographed by the camera 10A and the image photographed by the camera 10B into the bird's eye view coordinate system to acquire two bird's eye view images (Step S206). Next, the three-dimensional object detection unit 130 inputs the bird's eye view image corresponding to the camera 10A into the trained model 162 to detect a three-dimensional object (Step S208). Next, the three-dimensional object detection unit 130 detects an object with the identified position information based on the bird's eye view image corresponding to the camera 10B (Step S210). The processing of Step S208 and the processing of Step S210 may be executed in opposite order, or may be executed in parallel.

Next, the three-dimensional object detection unit 130 matches the detected three-dimensional object with the object with the identified position information to identify the position of the three-dimensional object (Step S212). Next, the space detection unit 140 excludes the three-dimensional object detected by the three-dimensional object detection unit 130 from the bird's eye view image to detect the travelable space FS1 of the subject vehicle M in the bird's eye view image (Step S214).

Next, the space detection unit 140 coverts the travelable space FS1 into the bird's eye view coordinate system, and matches the travelable space FS1 with the reference map to detect the travelable space FS2 on the reference map (Step S216). Next, the traveling control unit 150 generates the target trajectory TT such that the subject vehicle M passes through the travelable space FS2, and causes the subject vehicle M to travel along the target trajectory TT (Step S216). Then, the processing of this flow chart is finished.

According to the modification example described above, the mobile object control device 100 detects a three-dimensional object based on the bird's eye view image converted from the image photographed by the camera 10A, and refers to the bird's eye view image converted from the image photographed by the camera 10B to identify the position of the three-dimensional object. As a result, it is possible to detect the position of a three-dimensional object existing near the mobile object more accurately, and detect the travelable space of the mobile object more accurately.

The embodiment described above can be represented in the following manner.

A mobile object control device including a storage medium storing computer-readable commands and a processor connected to the storage medium, the processor executing the computer-readable commands to: acquire a subject bird's eye view image obtained by converting an image, which is photographed by a camera mounted in a mobile object to capture a surrounding situation of the mobile object, into a bird's eye view coordinate system; input the subject bird's eye view image into a trained model, which is trained to receive input of a bird's eye view image to output at least a three-dimensional object in the bird's eye view image, to detect a three-dimensional object in the subject bird's eye view image; detect a travelable space of the mobile object based on the detected three-dimensional object; and cause the mobile object to travel so as to pass through the travelable space.

This concludes the description of the embodiment for carrying out the present invention. The present invention is not limited to the embodiment in any manner, and various kinds of modifications and replacements can be made within a range that does not depart from the gist of the present invention.

What is claimed is:

1. A mobile object control device comprising a storage medium storing computer-readable commands and a processor connected to the storage medium, the processor executing the computer-readable commands to:
acquire a subject bird's eye view image obtained by converting an image, which is photographed by a camera mounted in a mobile object to capture a surrounding situation of the mobile object, into a bird's eye view coordinate system;
input the subject bird's eye view image into a trained model, which is trained to receive input of a bird's eye view image to output at least a three-dimensional object in the bird's eye view image, to detect a three-dimensional object in the subject bird's eye view image;
detect a travelable space of the mobile object based on the detected three-dimensional object; and
cause the mobile object to travel so as to pass through the travelable space.

2. The mobile object control device according to claim 1, wherein the trained model is trained to receive input of a bird's eye view image to output information indicating whether or not the mobile object is capable of traveling so as to traverse a three-dimensional object in the bird's eye view image.

3. The mobile object control device according to claim 1, wherein the trained model is trained based on first training data associating an annotation indicating a three-dimensional object with a region having a radial pattern centered about a center of a lower end of the bird's eye view image.

4. The mobile object control device according to claim 3, wherein the trained model is trained based on the first training data and second training data associating an annotation indicating a three-dimensional object with a region having a single color pattern different from a color of a road surface in the bird's eye view image.

5. The mobile object control device according to claim 3, wherein the trained model is trained based on the first training data and third training data associating indicating a non-three-dimensional object with a road sign in the bird's eye view image.

6. The mobile object control device according to claim 3,
wherein the processor uses an image obtained by capturing the surrounding situation of the mobile object by the camera to recognize an object included in the image, and generate a reference map in which a position of the recognized object is reflected, and
wherein the processor detects the travelable space by matching the detected three-dimensional object in the subject bird's eye view image with the generated reference map.

7. The mobile object control device according to claim 1,
wherein the camera comprises a first camera installed at the lower part of the mobile object and a second camera installed at the upper part of the mobile object,
wherein the processor uses a first subject bird's eye view image, which is obtained by converting an image capturing the surrounding situation of the mobile object by the first camera into the bird's eye view coordinate system, to detect the three-dimensional object,
wherein the processor uses a second subject bird's eye view image, which is obtained by converting an image capturing the surrounding situation of the mobile object by the second camera into the bird's eye view coordinate system, to detect an object in the second subject bird's eye view image and position information thereof, and
wherein the processor detects a position of the three-dimensional object by matching the detected three-dimensional object with the detected object with the position information.

8. The mobile object control device according to claim 1,
wherein the processor detects a hollow object shown in the image capturing the surrounding situation of the mobile object by the camera before converting the image into the bird's eye view coordinate system, and assigns identification information to the hollow object, and
wherein the processor detects the travelable space based further on the identification information.

9. The mobile object control device according to claim 1, wherein when a temporal variation amount of the same region in a plurality of time-series subject bird's eye view images with respect to a road surface is equal to or larger than a threshold value, the processor detects the same region as a three-dimensional object.

10. A mobile object control method to be executed by a computer, the mobile object control method comprising:
acquiring a subject bird's eye view image obtained by converting an image, which is photographed by a camera mounted in a mobile object to capture a surrounding situation of the mobile object, into a bird's eye view coordinate system;
inputting the subject bird's eye view image into a trained model, which is trained to receive input of a bird's eye view image to output at least a three-dimensional object in the bird's eye view image, to detect a three-dimensional object in the subject bird's eye view image;
detecting a travelable space of the mobile object based on the detected three-dimensional object; and
causing the mobile object to travel so as to pass through the travelable space.

11. A non-transitory computer-readable storage medium storing a program for causing a computer to:
acquire a subject bird's eye view image obtained by converting an image, which is photographed by a camera mounted in a mobile object to capture a surrounding situation of the mobile object, into a bird's eye view coordinate system;
input the subject bird's eye view image into a trained model, which is trained to receive input of a bird's eye view image to output at least a three-dimensional object in the bird's eye view image, to detect a three-dimensional object in the subject bird's eye view image;
detect a travelable space of the mobile object based on the detected three-dimensional object; and
cause the mobile object to travel so as to pass through the travelable space.

12. A learning device configured to perform learning so as to use training data associating an annotation indicating a three-dimensional object with a region having a radial pattern centered about a center of a lower end of a bird's eye view image to receive input of a bird's eye view image to output at least a three-dimensional object in the bird's eye view image.

13. A learning method to be executed by a computer, the learning method comprising performing learning so as to use training data associating an annotation indicating a three-dimensional object with a region having a radial pattern centered about a center of a lower end of a bird's eye view image to receive input of a bird's eye view image to output at least a three-dimensional object in the bird's eye view image.

14. A non-transitory computer-readable storage medium storing a program for causing a computer to perform learning so as to use training data associating an annotation indicating a three-dimensional object with a region having a radial pattern centered about a center of a lower end of a bird's eye view image to receive input of a bird's eye view image to output at least a three-dimensional object in the bird's eye view image.
